(19) United States
(12) Patent Application Publication
(10) Pub. No.: US 2009/0064443 A1
(43) Pub. Date: Mar. 12, 2009

(54) PAINT TRAY AND PAINT TRAY CARRIER WITH DEPLOYABLE HANDLE

(76) Inventor: Jacques LAJOIE, St-Jean-sur-Richelieu (CA)

Correspondence Address: BENOIT & CO., 1001, DE MALSONNEUVE WEST BOULEVARD, SUITE 210, MONTREAL, QC, H3A 3C8, CA

(21) Appl. No.: 12/269,337

(22) Filed: Nov. 12, 2008

Related U.S. Application Data
(63) Continuation-in-part of application No. 12/125,036, filed on May 21, 2008.
(60) Provisional application No. 60/931,009, filed on May 21, 2007.

(51) Int. Cl. B44D 3/12; A45F 5/00

(52) U.S. Cl. 15/257.06; 294/168

(57) ABSTRACT

The present document describes a paint tray comprising: a base for use in holding paint; a U-shaped arm having two arm ends pivotally coupled to the base; and a handle deployable from the U-shaped arm by sliding thereon. The handle is used in carrying the paint tray. The document also describes a paint tray comprising: an arm; a coupling means for attachment of the arm to the paint tray; and a handle deployable from the arm. The handle is used for carrying the paint tray. Finally, there is described a carrier for a drip pan for holding paint, the carrier comprising: an arm comprising a coupling means for engaging the drip pan; and a handle deployable from the arm. The handle is used for carrying the drip pan.

### CROSS-REFERENCE TO RELATED APPLICATIONS

This application is filed under 37 CFR 1.53(b) as a continuation-in-part application. This application claims priority under 35 USC §120 of U.S. patent application Ser. No. 12/125,036, filed May 21, 2008, and entitled “Paint tray with integrated transport handle”, which claims priority under 35 USC §119 of U.S. provisional application 60/931,009, filed May 21, 2007, the specifications of which are hereby incorporated by reference.

### TECHNICAL FIELD

This description relates to the field of paint tools. More particularly, this description relates to devices for holding and carrying paint.

### BACKGROUND OF THE INVENTION

Painters who use paint trays often need to move their paint trays around while painting surfaces. In this process, the painters must bend down to pick up the paint tray and, at the same time, ensure the paint roller stays in the paint tray. Upon moving the paint tray to another location, painters must find a place (e.g., a corner) to rest the handle stick of the paint roller. The embodiments described herein aim to resolve the aforementioned problems.

### SUMMARY OF THE INVENTION

According to an aspect of the invention, there is provided a paint tray comprising: a base for use in holding paint; a U-shaped arm having two arm ends pivotally coupled to the base; and a handle deployable from the U-shaped arm by sliding thereon. The handle is used in carrying the paint tray.

According to another aspect of the invention, there is provided a paint tray comprising: an arm; a coupling means for attachment of the arm to the paint tray; and a handle deployable from the arm. The handle is used for carrying the paint tray.

According to another aspect of the invention, there is provided a carrier for a drip pan for holding paint, the carrier comprising: an arm comprising a coupling means for engaging the drip pan; and a handle deployable from the arm. The handle is used for carrying the drip pan.

### BRIEF DESCRIPTION OF THE DRAWINGS

Further features and advantages of the present invention will become apparent from the following detailed description, taken in combination with the appended drawings, in which:

FIGS. 1a-d are a top view, an elevation, a rear view and a detailed elevation of a paint tray in a storage position, in accordance with an embodiment of the invention;

FIGS. 2a-c are a side elevation, a detailed top view, and a front elevation of the paint tray of FIGS. 1a-d in the “in use” position;

FIGS. 3a-d are side elevations of the paint tray of FIGS. 1a-d detailing steps retracting to storage position;

FIGS. 4a-b are perspective views of a paint tray in a use position and in a storage position in accordance with another embodiment of the invention;

FIG. 5 is a perspective view of a paint tray in a use position in accordance with another embodiment of the invention;

FIG. 6 is a perspective view of a paint tray in a use position in accordance with another embodiment of the invention;

FIG. 7 is a perspective view of a carrier in accordance with another embodiment of the invention; and

FIG. 8 is a perspective view of a carrier in an “in use” position in accordance with another embodiment of the invention.

It will be noted that throughout the appended drawings, like features are identified by like reference numerals.

### DETAILED DESCRIPTION

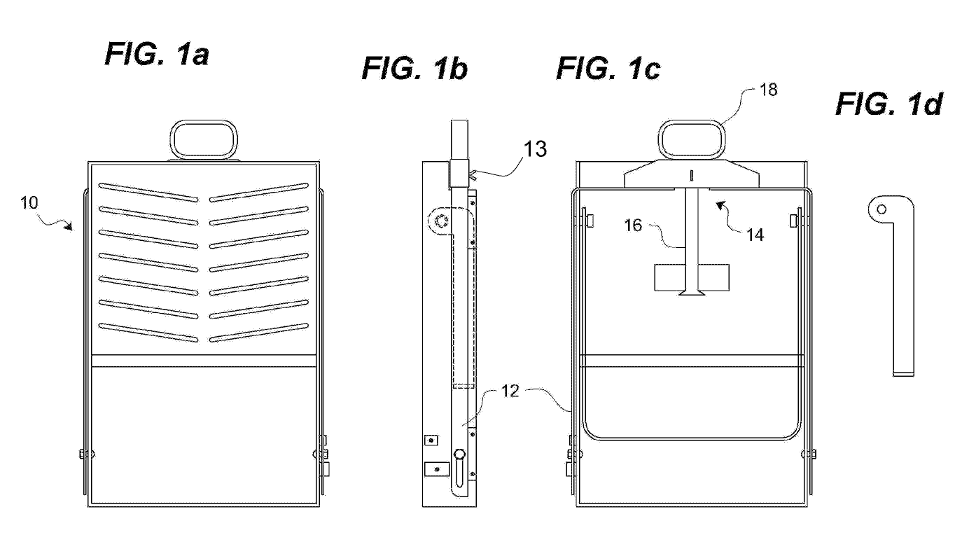

Referring to FIGS. 1a-d, 2a-c and 3a-d, there is shown a paint tray 10 according to an embodiment of the invention. A base 11 is for interfacing with the floor or with a step 42 of a stair, the base 11 comprises a drip pan for holding paint.

A hide-away stand 40 is pivotally coupled to the base 11 and is used in staircases and other inclined surfaces. The hide-away stand 40 is “U” shaped to make it easy for deployment. A U-shaped arm 12 is pivotally coupled to the base 11 by a mechanical linkage, namely a coupling means.

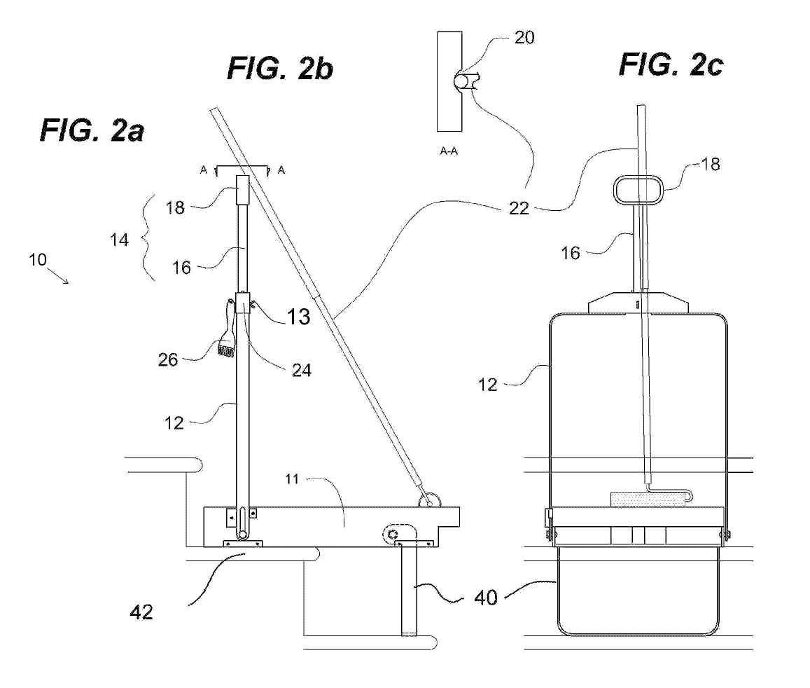

A blocking means 28 is fixed on the base 11 for limiting the range of movement of the U-shaped arm 12 with respect to the base 11. The blocking means 28 defines a use position of the U-shaped arm 12 (FIG. 2a) and a storing position of the U-shaped arm 12 (FIG. 1b).

From the center of the transversal portion of the U-shaped arm 12, a handle 14 is deployable by sliding thereon. A locking means 13 permits adjustment of the deployment of the handle 14 with respect to the U-shaped arm 12. The handle 14 consists of a shaft 16 that retracts and protracts from the U-shaped arm 12 and a grip section 18 with a built-in cradle 20, namely a resting means for resting handle stick 22. The U-shaped arm 12 also has a hook 24, namely a holding means for hanging a trimming brush 26.

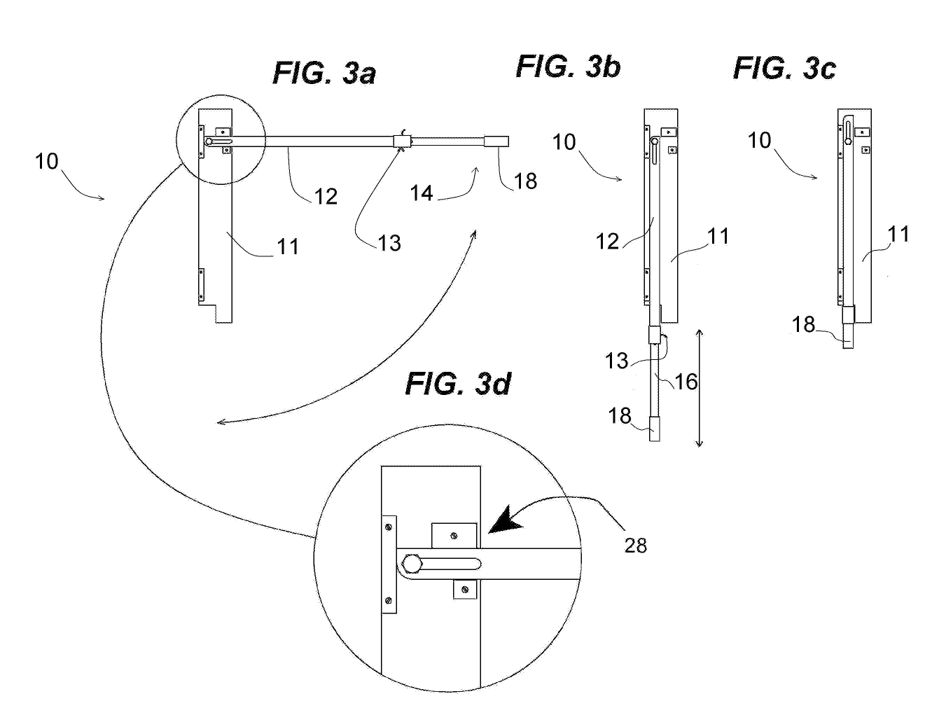

Starting from the paint tray 10 in an “in use” position, shown in FIG. 3a, a user folds the paint tray 10 in a storage position, shown in FIG. 3c, as follows. A first step consists of releasing the blocking means 28, then pushing the grip section 18 of the handle 14 toward the opposite side of the base 11 with respect to the coupling means detailed in FIG. 3d. The U-shaped arm 12 pivots until it is along the base 11 as shown in FIG. 3b. A second step consists in unlocking the locking means 13, then pushing the grip sections 18 toward the U-shaped arm 12. The handle 14 slides along the U-shaped arm 12 and the shaft 16 lodges under the base 11. In this storage position, the grip section 18 rests outside the base 11 for being moved as shown in FIG. 3c.

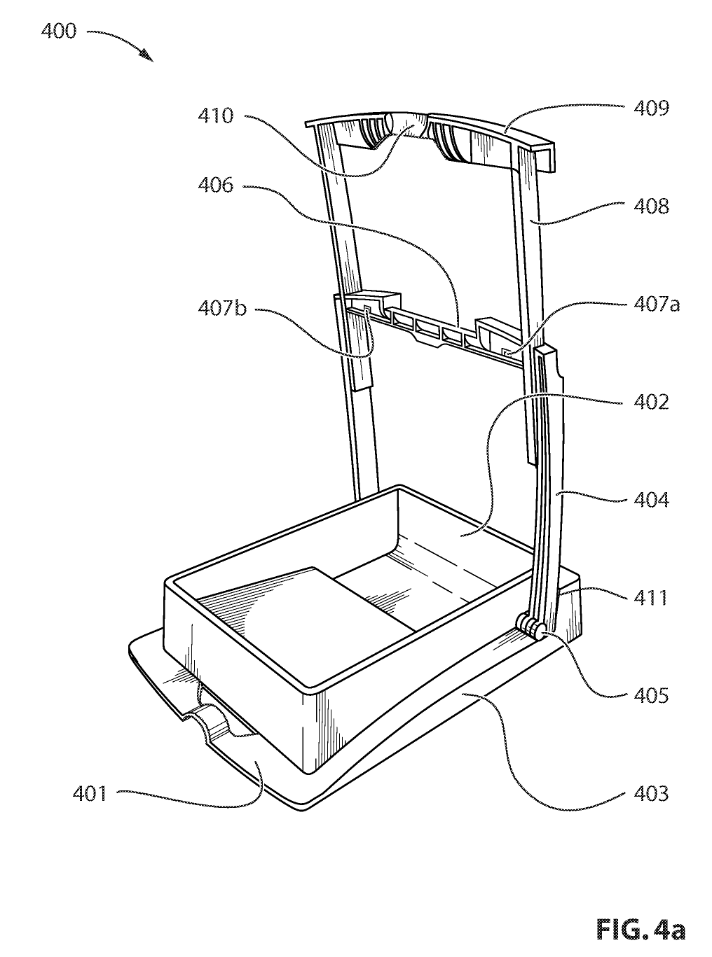

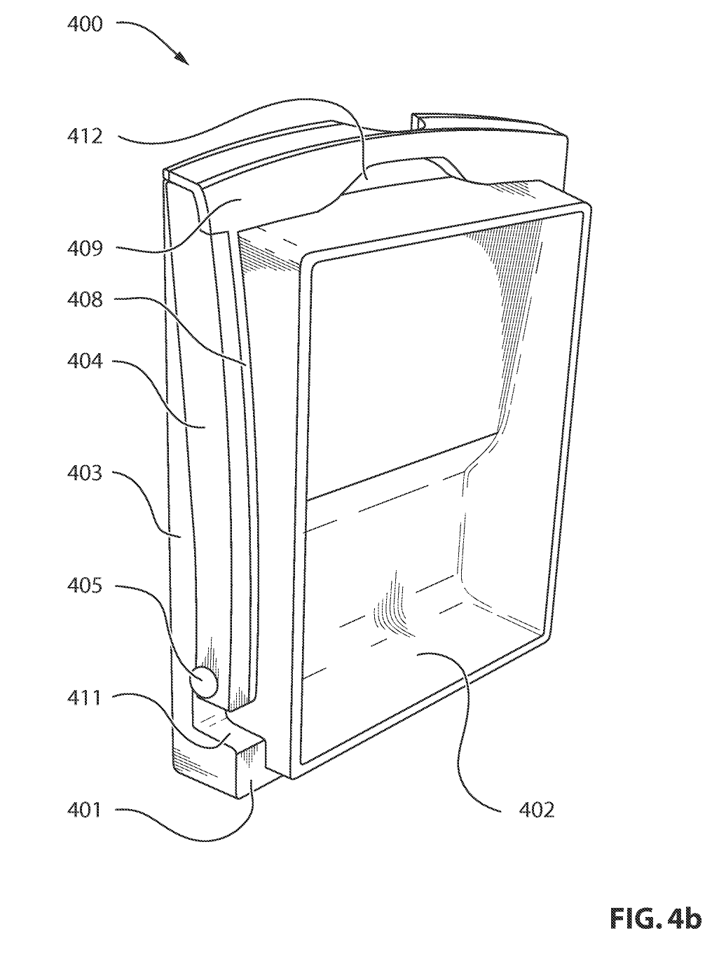

Now referring to FIG. 4a, there is shown a paint tray 400 in an “in use” position according to another embodiment of the invention. A base 401 is settled on a surface which is generally the floor of the location to be painted. In this embodiment, the base 401 is molded with a drip pan 402 for holding paint.

The base 401 has a first longitudinal side 403 and a second longitudinal side, not shown, opposite the first longitudinal side 403. From the first longitudinal side 403 and the second longitudinal side, a U-shaped arm 404 is pivotally coupled to the base 401 by a mechanical linkage, namely a coupling means including a first pivot 405 located on the first longitudinal side 403 and a second pivot, not shown, located on the second longitudinal side.

The U-shaped arm 404 comprises a transversal member 406 having hooks 407a-b, namely holding means for hanging paint tools such as brushes, rags, palette knives, spatulas or others. From the upper end of the U-shaped arm 404, a U-shaped handle 408 is deployed sliding from the U-shaped arm 404. The U-shaped handle 408 comprises a grip section 409 which is substantially parallel to the surface. At the middle of the grip section 409, a curved form creates a cradle 410, namely a resting means for receiving a handle of paint tools such as a roller. In this configuration, a user can easily move the paint tray 400, gripping it with the grip sections 409 without undue bending.

A blocking means for receiving the U-shaped arm 404 and then limiting the angular position of the U-shaped arm 404 with respect to the base 401 is arranged on the base 401. The blocking means comprises a first stop 411 located on the first longitudinal side 403 and in the neighborhood of the pivot 405 and a second stop, not shown, located on the second longitudinal side. In another embodiment, not shown, a U-shaped handle could slide directly from the transversal member of the U-shaped arm.

FIG. 4b depicts the paint tray 400 of FIG. 4a in a storage position. Starting from the paint tray 400 in use depicted in FIG. 4a, by pushing the grip sections 409 of the U-shaped handle toward the arm 404 and toward the opposite side of the base 401 with respect to the first pivots 405 and the second pivot, the U-shaped handle 408 slides along the U-shaped arm 404 which revolves around the first pivot 405 and the second pivot. In this storage position, the U-shaped handle 408 is retracted along the U-shaped arm 404, the U-shaped arm 404 is positioned along the length of the base 401 and the grip sections 409 is positioned along the width of the base 401. The grip section 409 and the transversal member 406 are designed for creating a passage 412 in the storage position. The passage 412 is for fingers of a user for gripping the paint tray 400 and moving it to the storage position.

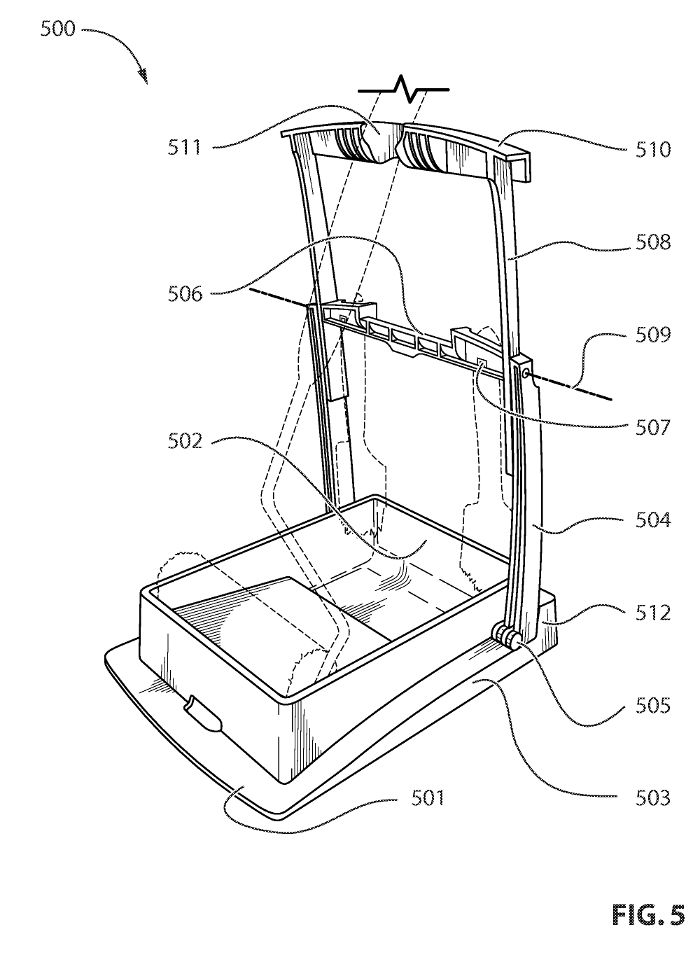

Now referring to FIG. 5, there is shown a paint tray 500 according to another embodiment of the invention. A base 501 is settled on a surface which is generally the floor of the location to be painted. In this embodiment, the base 501 is molded with a drip pan 502 for holding paint.

The base 501 has a first longitudinal side 503 and a second longitudinal side, not shown, facing the first longitudinal side 503. From the first longitudinal side 503 and the second longitudinal side, a U-shaped arm 504 is pivotally coupled to the base 501 by a mechanical linkage, namely a coupling means including a first pivot 505 located on the first longitudinal side 503 and a second pivot, not shown, located on the second longitudinal side.

The U-shaped arm 504 comprises a transversal member 506 having a first hook 507, namely a holding means and a second hook, not shown, both for hanging paint tools such as brushes. From the upper end of the U-shaped arm 504, a U-shaped handle 508 is deployed pivoting around a pivot axis 509 with respect to the U-shaped arm 504.

The U-shaped handle 508 comprises a grip section 510 which is substantially parallel to the surface. In the middle of the grip section 510, a curved form creates a cradle 511, namely a resting means for receiving the handle of a roller drawn with dashed lines. In this configuration, a user can easily move the paint tray 500, gripping it by the grip sections 510 without undue bending.

A blocking means for receiving the U-shaped arm 504 and then limiting the angular position of the U-shaped arm 504 with respect to the base 501 is arranged on the base 501. The blocking means comprises a first stop 512 located on the first longitudinal side 503 and in the neighborhood of the pivot 505 and a second stop, not shown, located on the second longitudinal side. In another embodiment, not shown, the arm could be a part of the base or of the drip pan or the arm could be demountably fastened on the base.

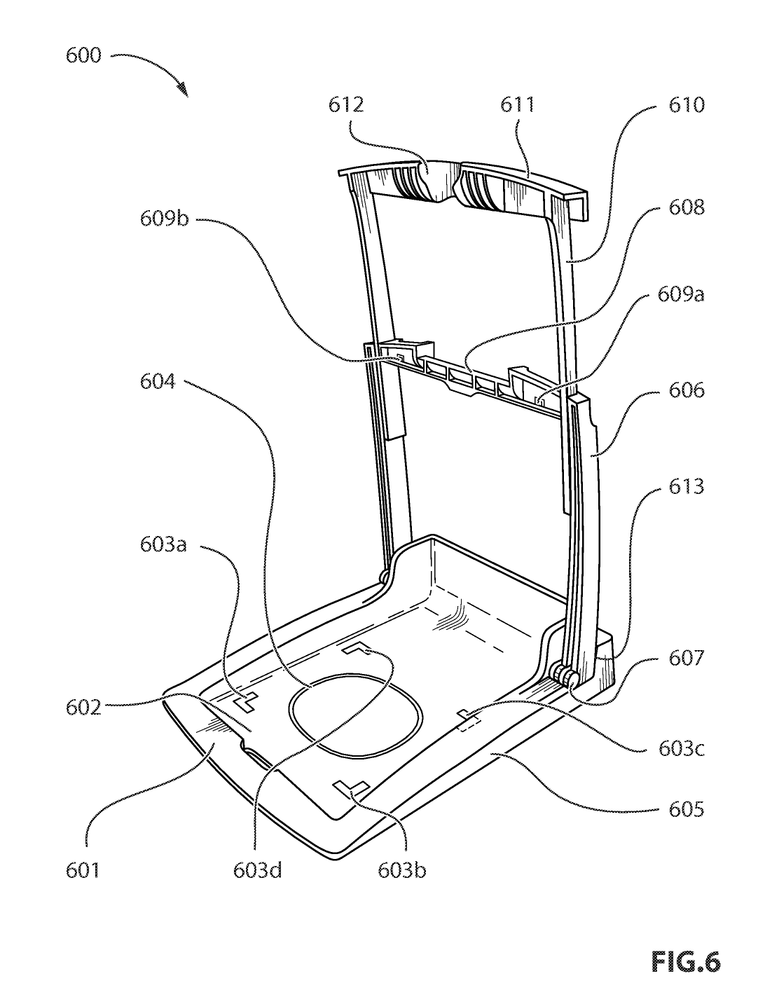

Now referring to FIG. 6, there is shown a paint tray 600 according to another embodiment of the invention. A base 601 is settled on a surface which is generally the floor of the location to be painted. In this embodiment, the base 601 is molded with a tray portion 602 for receiving a drip pan for holding paint or for holding a paint container.

The tray portion 602 comprises on its upper surface some protrusions 603a-b-c-d for preventing the drip pan or the paint container from sliding out of the tray portion 602. In addition, the tray portion 602 comprises on the upper surface a depression 604 for engaging paint cans. The base 601 has a first longitudinal side 605 and a second longitudinal side, not shown, facing the first longitudinal side 605. From the first longitudinal side 605 and the second longitudinal side, a U-shaped arm 606 is pivotally coupled to the base 601 by a mechanical linkage, namely a coupling means including a first pivot 607 located on the first longitudinal side 605 and a second pivot, not shown, located on the second longitudinal side.

The U-shaped arm 606 comprises a transversal member 608 having clamps 609a-b, seen from the back, namely holding means for hanging paint tools such as brushes, rags, palette knives, spatulas or others. From the upper end of the U-shaped arm 606, a U-shaped handle 610 is deployed sliding from the U-shaped arm 606.

The U-shaped handle 610 comprises a grip section 611 which is substantially parallel to the surface. At the middle of the grip section 611, a curved form creates a cradle 612, namely a resting means for receiving a handle of paint tools such as a roller. In this configuration, a user can easily move the paint tray 600, gripping it by the grip sections 611 without undue bending.

A blocking means for receiving the U-shaped arm 606 and then limiting the angular position of the U-shaped arm 606 with respect to the base 601 is arranged on the base 601. The blocking means comprises a first stop 613 located on the first longitudinal side 605 and in the neighborhood of the pivot 607 and a second stop, not shown, located on the second longitudinal side. In another embodiment, not shown, the arm could be U-shaped in a plan and bent in another plan normal to the U-shape plan.

Starting form the paint tray 600 described on FIG. 6, the coupling means in other embodiments of the invention, not shown, comprise one of a removable attachment for permitting assembling the arm to the paint tray and disassembling the arm from the paint tray; a permanent embedment of the arm with the paint tray; and a mechanical linkage for permitting movement of the arm with respect to the paint tray according to at least one degree of freedom.

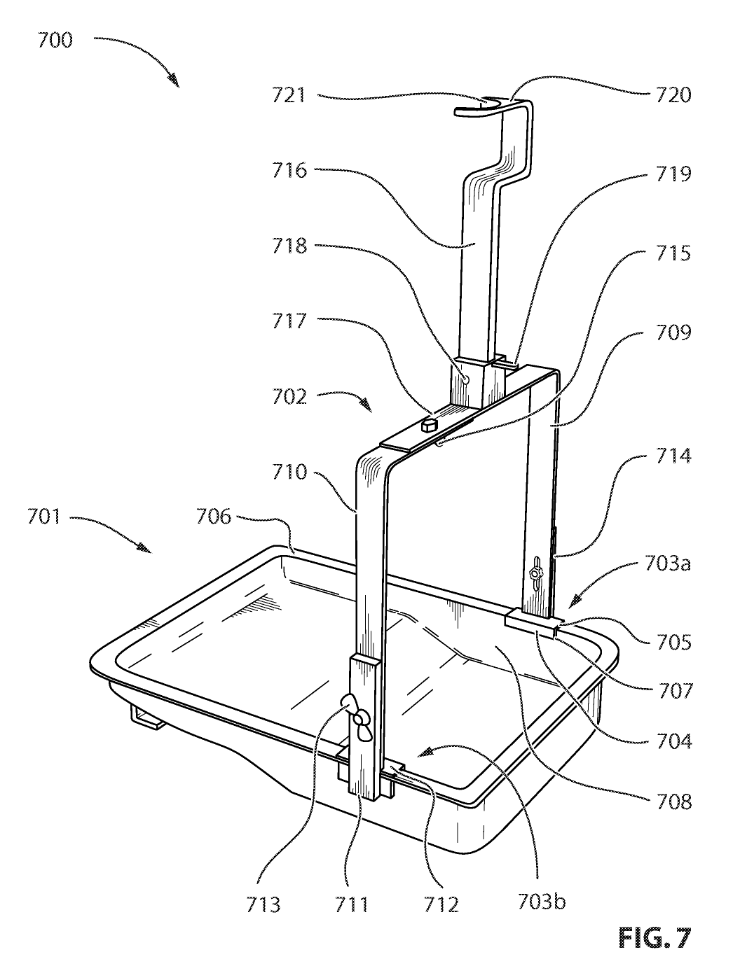

Now referring to FIG. 7, there is shown a carrier 700 engaged on a drip pan 701 according to another embodiment of the invention. A U-shaped arm 702 comprises a first end 703a and a second end 703b for coupling the arm 702 to the drip pan 701. The first end 703a and the second end 703b are symmetrical facing each other. The first end 703a comprises a first L-shaped base 704 fixed on a first branch 709 of the arm 702, a first wing 705 of the first L-shaped base 704 for receiving a top edge 706 of the drip pan 701 and a second wing 707 of the first L-shaped base 704 for receiving a first internal side 708 of the drip pan 701. The second end 703b comprises a second adjustable jaw 711 screwed on a second branch 710 of the U-shaped arms 702 with a thumbscrew 713. The second adjustable jaw 711 presses the top edge 706 and a second internal side, not shown, against a second L-shaped base 712.

The second L-shaped base 712 is fixed on the second branch 710. Symmetrically, a first adjustable jaw 714 presses the top edge 706 and the first internal side 708 against the first L-shaped base 704. Then, the first adjustable jaw 714 and the second adjustable jaw 711 fasten the drip pan 701.

The U-shaped arm 702 is widely adjustable with a thumbscrew 715. A hook 719, namely a holding means is fixed on the U-shaped arm 702 for hanging paint tool above the drip pan 701. A handle 716 is pivotally coupled to a transversal member 717 of the U-shaped arm 702 by a pivot 718. The top of the handle 716 is folded forming a horizontal grip section 720. The grip section 720 is notched, forming a cradle 721, namely a resting means for receiving the handle of a paint tool such as a roller. In another embodiment, not shown, the grip section could be deployable from the handle by sliding thereon or pivoting therefrom.

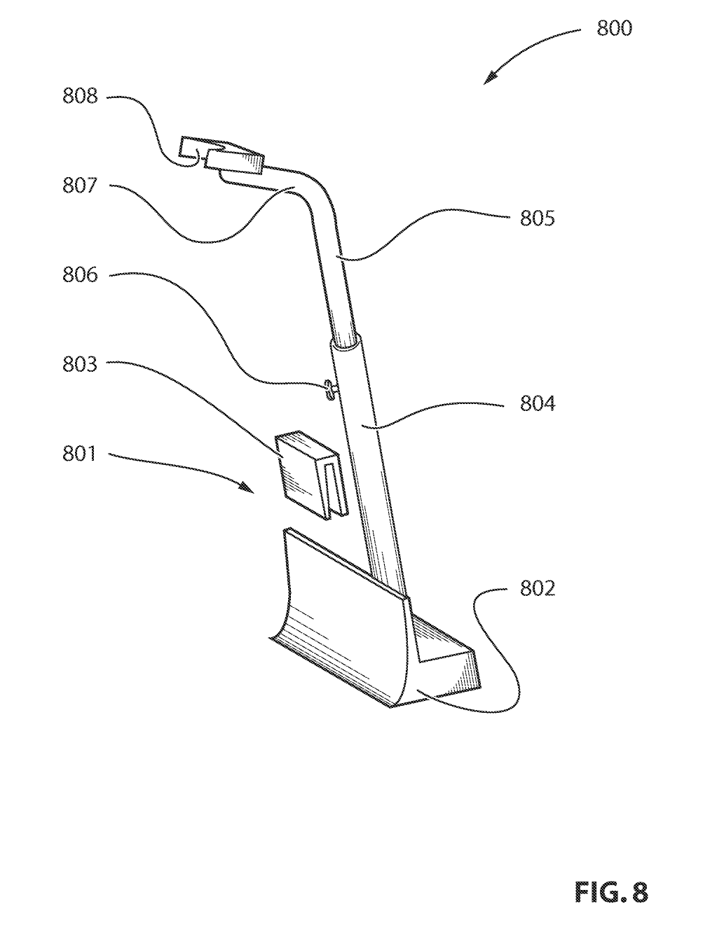

Ending with FIG. 8, there is shown a carrier 800 for engaging a drip pan according to another embodiment of the invention. A coupling means 801 comprises a shoe 802 for receiving a drip pan and a clamp 803 for attaching the drip pan to the shoe 802. Other types of coupling means, such as those shown in the other Figures, may also be used.

A tubular arm 804 is fixed to the shoe 802. A handle 805 is deployed upwardly from the tubular arm 804. A thumbscrew 806 screwed in the tubular arm 804 and presses on the handle 805. This is also referred to as a locking means and is used in adjusting the position of the handle 805 with respect to the tubular arm 804. The top of the handle 805 is bent forming a grip section 807 and includes a cradle 808. The cradle 808, namely a resting means, is for receiving the handle stick of a paint roller (not shown). In another embodiment, not shown, the handle 805 could be pivotally coupled to the top of the arm.

While preferred embodiments of the invention have been described above and illustrated in the accompanying drawings, it will be evident to those skilled in the art that modifications may be made therein without departing from the essence of this invention. Such modifications are considered as possible variants comprised in the scope of the invention.

1. A paint tray comprising:
a base for use in holding paint;
a U-shaped arm having two arm ends pivotally coupled to the base; and
a handle deployable from the U-shaped arm by sliding thereon, the handle for use in carrying the paint tray.

2. The paint tray of claim 1, wherein the base comprises one of a drip pan for holding paint and a tray portion for receiving one of a drip pan for holding paint and a paint container.

3. The paint tray of claim 1, wherein at least one of the U-shaped arm and the handle comprises a paint tool resting means or a paint tool holding means.

4. The paint tray of claim 1, wherein the paint tray is normally used on a surface which is substantially flat, the handle having a grip section and being deployable between a retracted position and a deployed position, the grip section being further from the surface in the deployed position than in the retracted position.

5. The paint tray of claim 4, wherein the grip section comprises a longitudinal portion which is substantially parallel to the surface.

6. The paint tray of claim 5, wherein the handle has one of: a U-shape having two handle ends for sliding on the U-shaped arm; and a shaft portion for sliding on the U-shaped arm.

7. The paint tray of claim 1, wherein the base comprises a blocking means for limiting the range of movement of the U-shaped arm.

8. A paint tray comprising:
an arm;
a coupling means for attachment of the arm to the paint tray; and
a handle deployable from the arm, the handle for carrying the paint tray.

9. The paint tray of claim 8, further comprising one of a drip pan for holding paint and a tray for receiving one of a drip pan for holding paint and a paint container.

10. The paint tray of claim 8, wherein the coupling means comprises one of:
a removable attachment for permitting assembling the arm to the paint tray and disassembling the arm from the paint tray;
a permanent embedment of the arm with the paint tray; and
a mechanical linkage for permitting movement of the arm with respect to the paint tray according to at least one degree of freedom.

11. The paint tray of claim 10, wherein the arm comprises one of:
a U shape having two arm ends forming part of the coupling means; and
a single member having an arm end forming part of the coupling means.

12. The paint tray of claim 10, wherein the handle deploys form the arm by at least one of sliding thereon and pivoting therefrom.

13. The paint tray of claim 8, wherein the paint tray is used on a surface which is substantially flat; wherein the handle has a grip section; wherein the handle is deployable between a retracted position and a deployed position, the grip section being further from the surface in the deployed position than in the retracted position.

14. The paint tray of claim 8, wherein the coupling means comprises a blocking means for limiting the range of movement of the arm.

15. The paint tray of claim 8, wherein the grip section is deployable from the handle.

16. A carrier for a drip pan for holding paint, the carrier comprising:
an arm comprising a coupling means for engaging the drip pan; and
a handle deployable from the arm, the handle for carrying the drip pan.

17. The carrier of claim 16, wherein the arm comprises one of:
a U shape having two arm ends forming part of the coupling means; and
a single member having an arm end forming part of the coupling means.

18. The carrier of claim 16, wherein the handle deploys form the arm by at least one of sliding thereon and pivoting therefrom.

19. The carrier of claim 16, further comprising a locking means, wherein the drip pan is used on a surface which is substantially flat, wherein the handle has a grip section, wherein the handle is deployable between a retracted position and a deployed position, the grip section being further from the surface in the deployed position than in the retracted position, the locking means for maintaining the handle in an intermediate position between the retracted position and the deployed position, thereby permitting an adjustment of the distance between the grip section and the surface.
